(19) United States
(12) Patent Application Publication
(10) Pub. No.: US 2007/0076913 A1
(43) Pub. Date: Apr. 5, 2007

(54) Hearing aid apparatus and method

(75) Inventor: Richard W. Schanz, St. George, UT (US)

Correspondence Address: MARCUS G THEODORE, PC, 466 SOUTH 500 EAST, SALT LAKE CITY, UT, 84102, US

(73) Assignee: Shanz II, LLC, St. George, UT (US)

(21) Appl. No.: 11/520,990

(22) Filed: Sep. 14, 2006

Related U.S. Application Data
(60) Provisional application No. 60/722,621, filed on Oct. 3, 2005.

(51) Int. Cl. H04R 25/00

(52) U.S. Cl. 381/381; 381/370

(57) ABSTRACT

An improved hearing aid and method that employs a combination microphone/speaker, sized to be inserted within which the opening of the ear canal such that it does not obstruct the same for more natural hearing.

### RELATED APPLICATIONS

This application is a continuation-in-part of the provisional patent application entitled “Hearing Aid Apparatus and Method” filed Oct. 3, 2005, Ser. No. 60/722,621.

### BACKGROUND OF THE INVENTION

1. Field of Invention

The present invention relates to hearing aids. In particular, it relates to an improved hearing aid and method that employs a combination microphone/speaker, inserted within the opening of the ear canal and sized not to obstruct the same.

2. Description of Related Art

Various hearing aids and earpiece devices are known in the art. Taenzer et al, U.S. Pat. No. 6,445,799B1 provides a noise cancellation earpiece with an ear canal tube sized for positioning in an ear canal so that the ear canal is at least partially open for directly receiving ambient sounds. It is designed to send an inverse noise signal into the ear canal thereby substantially canceling the ambient noise in the ear canal. Takada, U.S. Publication No. 2003/0095677A1 discloses a hearing aid adapted to primarily listed to a desired sound when a hearing impaired person makes conversation to others or is watching television. It employs bone conduction speakers connected with a headset yoke with a central magnetic pole surrounded by a voice coil to allow one to hear in noisy environments. Boesen, U.S. Pat. No. 6,718,043B1 discloses a voice sound transmitting apparatus and system with a voice sound transmitting and receiving unit having an earpiece that is adapted for insertion into the external auditory canal of a user. The voice sound-transmitting unit includes a sensor, which may be a bone conduction sensor an air conduction sensor, or both. Prior to transmission, an additional processing modification or formatting of sensor output may be done. Stites, III, U.S. Pat. No. 5,208,867 discloses a voice transmission system and method for high ambient noise conditions employing an earpiece that fills the entire external auditory canal of a user. Stites, III, U.S. Pat. No. 5,327,506 discloses another voice transmission system and method for high ambient noise conditions employing a similar type of earpiece that fills the entire external auditory canal of a user. Pluvinage et al, U.S. Pat. No. 5,987,146 discloses an ear canal microphone providing an open ear canal hearing aid system. It has a plurality of ear canal tubes sized for positioning in an ear canal so that the ear canal is at least partially open for directly receiving ambient sounds. Fretz et al, U.S. Pat. No. 6,275,596B1 discloses another open ear canal hearing aid system with the speaker positioned in the ear canal leaving it partially open. Anderson et al, U.S. Pat. No. 6,704,423B2 discloses a hearing aid assembly having a directional microphone aligned in a forward direction mounted externally to a hearing aid body, which may have an in-the-canal or completely-in-the-canal mounting.

Cited for general interest is the Bordewijk, U.S. Pat. No. 6,577,740B1 disclosing a hearing aid for placement in an ear including a carrier, an enclosure, a microphone, a battery and a speaker inserted within the ear canal to totally obstruct the same. Valley et al, U.S. Pat. No. 4,259,547 discloses a hearing aid with a dual pickup for use in a high noise environment.

None of the above references provides a hearing aid with a combination microphone/speaker arrangement positioned within the ear canal, which provides an open ear canal hearing aid system for use with a variety of battery powered amplification hearing aid devices.

### SUMMARY OF THE INVENTION

The present invention comprises a method and apparatus employing a universal combination microphone/speaker operably associated via a transmission line with a behind the ear hearing aid amplifier and power source. The transmission line is connected to a support with a circuit leading to the combination microphone/speaker to position the combination microphone/speaker within the center of the exterior ear canal. A positioning wire is attached to the combination microphone/speaker adapted to be bent to fit within the exterior bowl of the ear and assist in holding the combination microphone/speaker within the ear canal. Thus positioned, the combination microphone/speaker takes advantage of the sound collecting properties of the exterior ear to funnel and capture sound to direct it to the microphone of the combination microphone/speaker. This combination microphone/speaker is axially aligned and structured such that when placed within the ear canal the microphone is directed toward the exterior of the ear and the speaker is located within the ear canal to direct amplified sound therein. Preferably the speaker includes a wax cap to prevent obstruction.

The combination microphone/speaker is sized to only partially obstruct the ear canal when inserted to reduce wind noise and produce a more natural sound. The open ear canal allows for minimal amplification and avoids an echo chamber sound. It also avoids the plugged up feeling caused by other hearing aids, which fully obstruct the ear canal.

The bendable support with circuitry means is generally fitted in one visit to an audiologist so that it is placed within the antiragus to hold the combination microphone/speaker in position within the external auditory canal of the ear. It is then connected to the behind the ear hearing aid sound processor and amplifier and power source via a plug socket system.

The transmission line has a three or four prong connector to plug into the behind the ear hearing aid sound processor, which includes an on-off switch to conserve the life of the battery when not in use. The on-off switch is also employed to shut off the device when a user takes a telephone call. By employing different prong connectors, the combination microphone/speaker may be used with different model behind the ear hearing aid sound processors and amplifiers.

In operation, after the combination microphone/speaker is positioned within the ear canal, the microphone picks up the sound as it is funneled into the ear in a natural manner. The microphone signals are then transmitted to the behind the ear processor for processing via one of a two channel transmission line. The processor then translates and amplifies the microphone signals, and sends them back to the speaker via the second channel of the transmission line to amplify the sound entering the ear canal.

The present invention is therefore particularly adapted to provide an easily fittable universal combination microphone/speaker system within an unobstructed ear canal to provide more nature sound pick up and transmission.

### BRIEF DESCRIPTION OF THE DRAWINGS

FIG. 1 is a side view of a preferred embodiment of the invention attached to a hearing aid and positioned on an ear.

FIG. 2 is a side view of the embodiment of FIG. 1.

FIG. 3 is a front view of the embodiment shown in FIG. 1.

FIG. 4 is a side view of the combination microphone speaker

FIG. 5 is a perspective view of an embodiment of the invention.

### DESCRIPTION OF THE ILLUSTRATED EMBODIMENTS

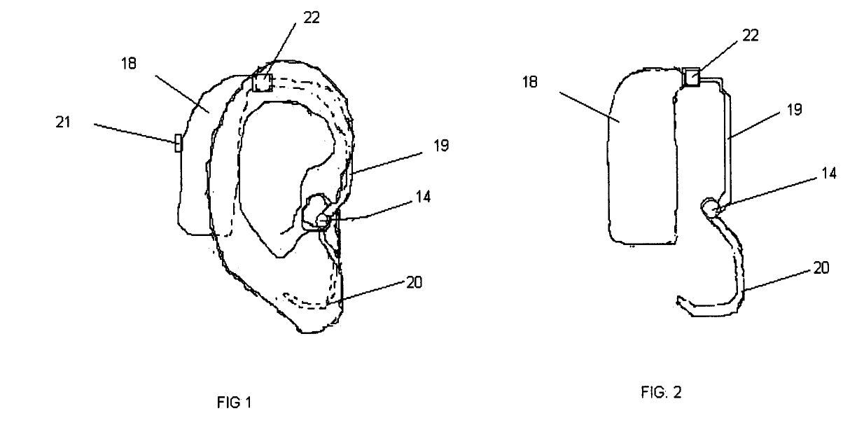

The Microphone Hearing Aid System 10 is shown in the attached drawings. FIG. 1 is a side view of a preferred embodiment of the invention attached to a sound processor 18 and positioned on a wearer's right ear. It comprises a long thin approximately ⅛^{th} inch in diameter combination microphone/speaker 12 with a microphone 14 at one end and a speaker 16 with wax cap 24 at the other end as shown in greater detail in FIG. 4. The long thin microphone/speaker 12 unit is connected to a behind the ear sound processor 18 with a vinyl coated transmission line 19 attached to a positioning wire 20 so that the speaker protrudes into the ear canal about V₂ inch. The transmission line 19 is firm yet bendable to fit the contours of the ear.

In this position, the microphone picks up the funneled sound, as described above. The microphone 14 signals are then transmitted to the processor 18 via the transmission line 19 for processing. The processor 18 then transmits the amplified signal via the transmission line 19 to the speaker 12 to direct the amplified sound into the inner ear. In the preferred embodiment, the microphone, as well as the speaker, is suspended in the center of the ear canal, without touching the ear canal wall. This is possible because the transmission line 19 and the combination microphone/speaker have such a small diameters.

The positioning wire 20 is made of rust proof spring wire, which allows it to be formed to fit within the bowl of the ear for positioning the combination microphone/speaker 12. The positioning wire 20 may also be vinyl coated, which is firm yet bendable to fit different contours of the outer ear so that it rests in the bowel of the ear. It thus is rust proof and can be readily fitted without the need for multiple visits to an ear specialist.

The diameter of the combination microphone/speaker 12 is sized to be inserted within the ear canal without plugging said ear canal. The unobstructed positioning of this combination microphone/speaker 12 within the ear canal allows air circulation, and requires minimal amplification. It also reduces wind noise to produce a more natural sound. It is also virtually invisible and prevents echo chamber sounds.

The microphone/speaker 12 is operably associated with a sound processor 18 with a battery (not shown) and preferably includes an on/off switch 21 to selectively activate the same. This is especially important for shutting down the hearing aid for telephone use by the wearer.

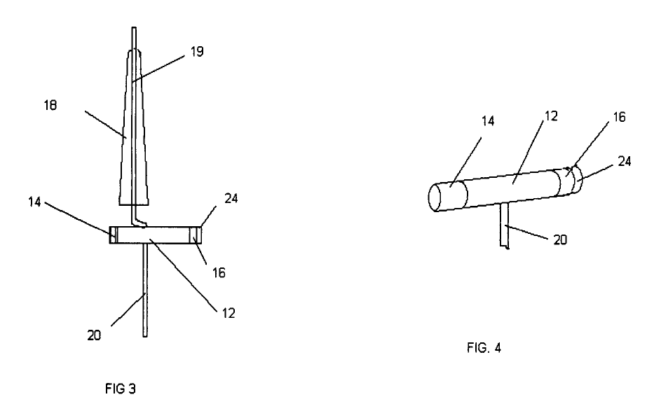

FIG. 2 is a side view of the embodiment of FIG. 2 attached to a sound processor 18 shown before bending the positioning wire 20 for mounting on the ear. FIG. 3 is a front view of the embodiment shown in FIG. 1 showing how the microphone/speaker 12 is elevated and held in position by the transmission line 19 and positioning wire 20 placed in the bowel of the ear.

FIG. 4 is a perspective view of the combination microphone speaker 12 in an aligned cylindrical configuration, although other alignment designs are contemplated.

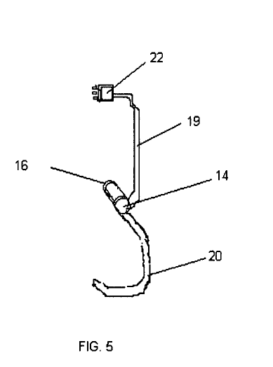

FIG. 5 illustrates a perspective view of the preferred embodiment of FIG. 1 with a three or four prong connector 22, which is adapted to interconnect to different manufacturers' sound processors 18 via either a three or four prong connector system 22.

Thus, the employment of the combination microphone speaker 12 with a sound processor 18 provides a more natural hearing system and method.

The size of the universal combination microphone/speaker 10 is preferably structured to come in three standard lengths to accommodate the different sized ears and ear canals. Thus inventory sizes are reduced as these three lengths accommodate almost all different ear sizes.

The above description and specification should not be construed as limiting the scope of the appended claims. The claims themselves recite those features deemed essential for the invention.

I claim:

1. A universal combination microphone/speaker comprising:
a. a base with a first end and a second end,
b. a microphone attached to the first end,
c. a speaker attached to the second end; the base, microphone, and speaker sized to fit within and partially obstruct the exterior ear canal to allow air to flow there through to minimize echoes and provide more natural sound pick up and transmission,
d. a bendable support attached to the base adapted to fit within the bowl of the outer ear and position the speaker such that it is positioned within the exterior ear canal pointed toward the inner ear to direct amplified sound therein, and position the microphone aligned toward the exterior of the ear to pickup sound focused by the exterior sound funneling of the outer ear, and
e. a transmission line with one end operably associated with the microphone and speaker and the other end having a connector end to mate with a behind the ear hearing aid sound processor and amplifier and power source to selectively activate the microphone and speaker.

2. A universal combination microphone/speaker according to claim 1, including a wax cap associated with the speaker to prevent obstruction.

3. A universal combination microphone/speaker according to claim 1, wherein the transmission line has three or four cables with a three or four prong connector to plug into the behind the ear hearing aid sound processor.

4. A universal combination microphone/speaker according to claim 3, wherein the power source is a battery and includes an on-off switch to selectively activate the battery

5. A universal combination microphone/speaker according to claim 1, wherein the transmission line is interchangeable with different prong connector ends and lengths for use with different hearing aid sound processors and amplifiers and different sized wearers.

6. A method of using a combination microphone/speaker comprising:
a. fitting a bendable support around the exterior of a user's ear of a combination microphone/speaker having
i. a base with a first end and a second end,
ii. a microphone attached to the first end,
iii. a speaker attached to the second end; the base, microphone, and speaker sized to fit within and partially obstruct the exterior ear canal to allow air to flow there through to minimize echoes and provide more natural sound pick up and transmission,
iv. a bendable support attached to the base adapted to fit within the bowl of the outer ear and position the speaker such that it is positioned within the exterior ear canal pointed toward the inner ear to direct amplified sound therein, and position the microphone aligned toward the exterior of the ear to pickup sound, and
v. a transmission line with connector ends;
b. connecting one end of the transmission line to the microphone and speaker,
c. connecting the other end following the bendable support to mate with a behind the ear hearing aid sound processor and amplifier and power source to selectively activate the microphone and speaker.

7. A method of using a combination microphone/speaker according to claim 6, wherein the bendable support with transmission line is generally fitted in one visit to an audiologist so that it is placed within the antiragus to hold the combination microphone/speaker in position within the external auditory canal of the ear.
